(19) United States
(12) Patent Application Publication
(10) Pub. No.: US 2008/0297887 A1
(43) Pub. Date: Dec. 4, 2008

(54) Lens array sheet and method for manufacturing same

(75) Inventor: Yoshihiro Yoshihara, Niigata (JP)

Correspondence Address: OSHA LIANG L.L.P., TWO HOUSTON CENTER, 909 FANNIN, SUITE 3500, HOUSTON, TX, 77010, US

(73) Assignee: Arisawa Mfg. Co., Ltd., Niigata (JP)

(21) Appl. No.: 11/545,019

(22) Filed: Oct. 6, 2006

Related U.S. Application Data
(60) Provisional application No. 60/725,428, filed on Oct. 11, 2005.

(51) Int. Cl. F21V 9/06; B29D 11/00; G03B 21/56

(52) U.S. Cl. 359/361; 359/443; 264/1.1

(57) ABSTRACT

A lens array sheet is provided. The lens array sheet includes: a transparent sheet-like lens side base material 140; a plurality of lenses formed on one surface of the lens side base material 140; a transparent sheet-like light shielding base material 160 which is laminated on the rear surface of the one surface of the lens side base material 140; and a light shielding pattern 180 formed on the rear surface of the surface laminated on the lens side base material 140 in the light shielding base material 160 that transmits visible light at a part corresponding to the focal point of the plurality of lenses 120 and shields the visible light at the other part.

### BACKGROUND OF THE INVENTION

### Field of the Invention

The present invention relates to a lens array sheet and a method for manufacturing the lens array sheet. Particularly, the present invention relates to a lens array sheet one of which surface has a plurality of lenses and the other of which surface has a light shielding pattern.

Usually, a sheet-like lens array that diffuses image light is used as a transmission screen that transmits image light. In the lens array, a plurality of single lenses are arranged in a matrix in a plane on a side on which image light is incident of a sheet-like substrate. Additionally, the lens array includes on an observing side a light shielding layer on which a plurality of apertures are formed centering around the focal point for each of the single senses (hereinafter referred to as a black matrix).

As a method of forming the black matrix, a method that a light shielding positive resist is used is disclosed as, for example, in Japanese Patent Application Publication No. 2000-147215. This method includes the steps of: forming a light shielding positive resist layer on the observing side of a lens array; irradiating a parallel lights from the incident side; exposing the light shielding positive resist layer in the focused region of the lens to the light and developing the same; and removing the positive resist material in the focused region. Thereby a black matrix is formed on a region other than the focused region on the surface of the observing side of the lens array.

However, in order to form the black matrix on the surface of the observing side of the lens array according to the above described method, it is preferred that the thickness of the lens array is substantially the same as the focal distance of the lenses. Therefore, when the black matrix is formed on the surface of the observing side of the lens array according to the method, the thickness of the substrate for the lens array could be determined dependent on the focal distance of the lenses formed on the surface of the incident side.

Accordingly, if the optical shape of a single lens is determined, the thickness of the substrate of the lens array could be automatically determined, so that a design freedom is reduced. Additionally, since a substrate having the different thickness has to be prepared every time the optical shape of the single lens is changed, the work and the cost for manufacturing is increased. Further, since the setting of a manufacturing apparatus, such as a clearance for conveying a sheet-like lens array by a roll has to be changed every time a lens array having lenses with different focal distance is manufactured, the work and the cost for manufacturing is further increased.

### SUMMARY

To solve the above described problems, a first aspect of the present invention provides a lens array sheet. The lens array sheet includes: a transparent sheet-like lens side base material; a plurality of lenses formed on one surface of the lens side base material; a transparent sheet-like light shielding base material laminated on the rear surface of the surface laminated on the lens side base material; and a light shielding pattern formed on the rear surface of the surface laminated on the lens side base material in the light shielding side base material that transmits visible light at a part corresponding to the focal point of the plurality of lenses and shields the visible light at the other part. Thereby even if the focal distance of the lenses is changed, the thickness of the whole lens array sheet is changed by changing the thickness of the light shielding side base material, so that a light shielding pattern can be formed. Therefore, the thickness of the lens side base material can be fixed.

Additionally, in the lens array sheet, the light shielding side base material may contain a UV absorber. Thereby when the lens array sheet is used, the lens side base material can be prevented from being deteriorated with ultraviolet rays contained in the outside light, for example.

Additionally, in the lens array sheet, the lens array side base material and the light shielding side base material may be laminated each other with adhesive or binder. Thereby the strength of the lens array sheet can be improved.

Additionally, in the lens array sheet, the thickness of the lens side base material may be less than the focal distance of a plurality of lenses. Thereby a lens array sheet having lenses with the various optical shapes can be manufactured without changing the thickness of the lens side base material, and the freedom for selecting the thickness of the lens side base material can be increased. Additionally, when the lens side base material is conveyed by a roll in manufacturing a lens array sheet, the lens side base material can be easily drawn from the roll and wound around the roll.

In this case, when the light shielding side base material is laminated on the lens side base material, the thickness of the light shielding side base material may be a thickness such that the position of the light shielding pattern becomes the focal distance of the plurality of lenses. Thereby the amount of parallel lights incident on the lens 120, which is shielded by the light shielding pattern 180 can be reduced. Additionally, when the light shielding pattern is formed by a self-alignment method, the ratio of the light shielding pattern to the surface of the observing side on the light shielding side base material can be increased, so that the contrast of the image light can be significantly improved.

A second aspect of the present invention provides a method for manufacturing a lens array sheet. The method includes the steps of: providing a sheet-like lens side base material which is made of a transparent UV curable resin; forming a plurality of lenses on one surface of the lens side base material by pushing the UV curable resin onto a lens pattern and irradiating the same with ultraviolet rays; providing a light shielding side base material with a photosensitive material layer on one surface of a transparent sheet; laminating the rear surface of the one surface of the lens side base material and the rear surface of the one surface of the light shielding side base material each other; and curing the photosensitive material layer at the part corresponding to the focal point of the plurality of lenses in the light shielding side base material by irradiating light from the one surface of the lens side base material to form a light shielding pattern. Here, in the manufacturing method, the part corresponding to the focal point of the plurality of lenses in the light shielding side base material may be stress-ruptured instead of curing a part of the photosensitive material layer corresponding to the focal point of the plurality of lenses in the light shielding side base material. Thereby the shape of the lenses formed on the one surface of the lens side base material can be changed without changing the thickness of the lens side base material and the setting of the apparatus for forming lenses, such as a clearance for conveying the lens side base material by a roll.

In the manufacturing method, the lens pattern may be arranged on the side surface of cylindrical shape rotating around an axis and ultraviolet rays may be irradiated from the outside of the cylindrical shape. Thereby the lenses can be easily and simply formed in comparison with the case that ultraviolet rays are irradiated from the inside of the cylindrical shape.

The summary of the invention does not necessarily describe all necessary features of the present invention. The present invention may also be a sub-combination of the features described above.

### BRIEF DESCRIPTION OF THE DRAWINGS

FIG. 1 is a cross sectional view showing a configuration of a lens array sheet 100 according to an embodiment of the present invention;

FIG. 2 shows an example of method for manufacturing the lens array sheet 100; and

FIG. 3 is a cross sectional view showing the lens array sheet for each step of the manufacturing method shown in FIG. 2.

### DESCRIPTION OF EXEMPLARY EMBODIMENTS

Aspects of the invention will now be described based on the preferred embodiments, which do not intend to limit the scope of the present invention, but exemplify the invention. All of the features and the combinations thereof described in the embodiment are not necessarily essential to the invention.

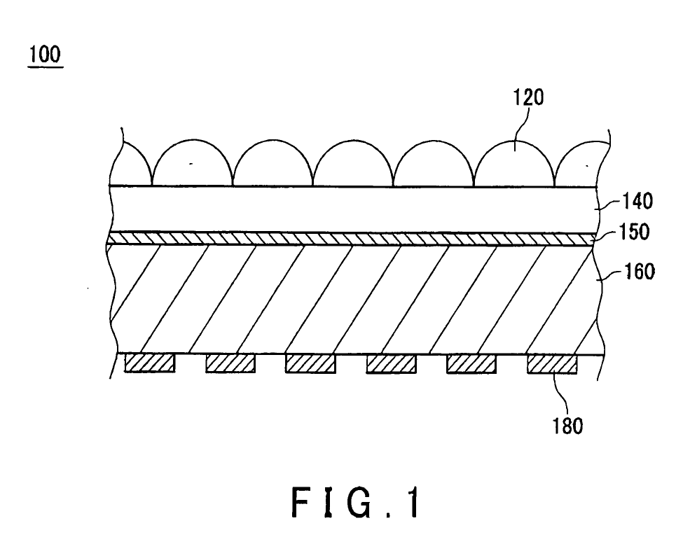

FIG. 1 is a cross sectional view showing a configuration of a lens array sheet 100 according to an embodiment of the present invention. The lens array sheet 100 diffuses and transmits light incident from a side on which lenses 120 are formed during absorbing light incident from a side on which a light shielding pattern 180 is formed to increase the contrast. Hereinafter, when the lens array sheet is a transmission screen used for a rear projection television, a side of one surface on which an image light is incident from a light source is referred to as an incident side, and the other side opposed to the incident side is referred to as an observing side.

As shown in FIG. 1, the lens array sheet 100 according to the present embodiment includes a plurality of lenses 120, a sheet-like lens side base material 140, an adhesive layer 150, a light shielding side base material 160 and a light shielding pattern 180 in the order from the incident side to the observing side. Each of the plurality of lenses 120 is a spherical microlens or an aspherical microlens. The plurality of lenses 120 are arranged with a pitch of 5-100 μm on the surface of the incident side on the lens side base material 140 in a matrix in a plane. Thereby the parallel lights incident from the incident side is transmitted in the optical axial direction and diffused in the direction to which the lenses 120 are arranged.

The adhesive layer 150 on which adhesive has been applied is provided on the surface of the observing side on the lens side base material 140. The surface of the observing side on the lens side base material 140 and the surface of the incident side on the light shielding side base material 160 are laminated each other with the adhesive layer 150.

Meanwhile, the light shielding pattern 180 is provided on the surface of the observing side on the light shielding side base material 160. The light shielding pattern 180 has a pattern on which each aperture is formed adjacent to the optical axis for each of the lenses 120. The light shielding pattern 180 absorbs light, particularly visible light on the region other than the apertures.

In the lens array sheet 100 shown in FIG. 1, the thickness of the lens side base material 140 is less than the focal distance of the lenses 120. Thereby the lens array sheet 100 having lenses 120 with various optical shapes can be manufactured without changing the thickness of the lens side base material 140. Additionally the freedom for selecting the thickness of the lens side base material can be increased. Further, the thickness of the lens side base material 140 is less than the thickness of the light shielding side base material 160, so that the lens side base material 140 can be easily bent. Additionally, when the light shielding side base material 160 is laminated on the lens side base material 140, the thickness of the light shielding side base material 160 is a thickness such that the position of the light shielding pattern 180 becomes the position of the focal distance of the lenses 120. Thereby the amount of parallel lights incident on the lens 120, which is shielded by the light shielding pattern 180 can be reduced.

Here, in order to strengthen the lens array sheet 100, a transparent reinforcing sheet may be further laminated on the light shielding pattern 180 side. In this case, a material for the reinforcing sheet may be selected among such as acryl, copolymer of methyl methacrylate and styrene, and polycarbonate.

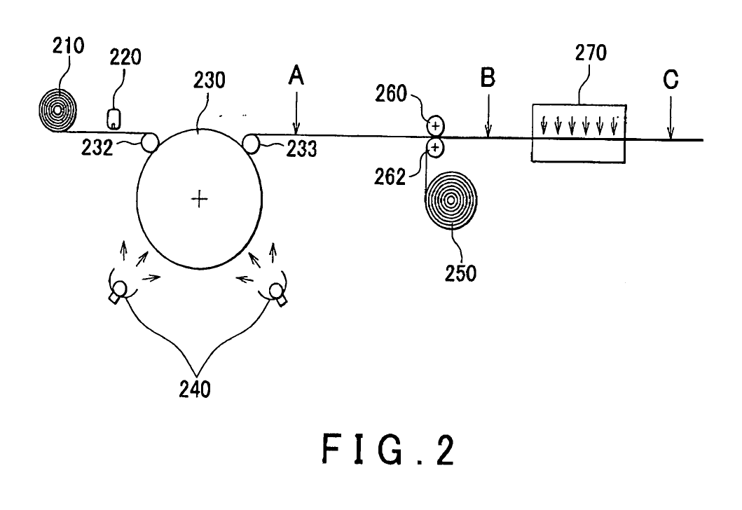

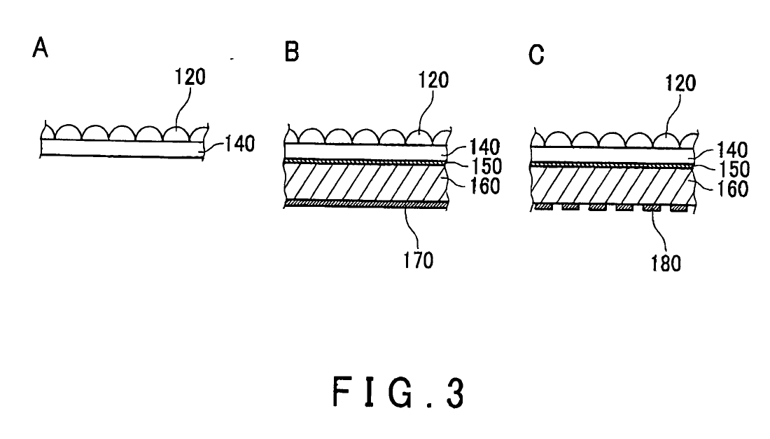

FIG. 2 shows an example of method for manufacturing the lens array sheet 100. Each of FIG. 3A-3C shows a cross sectional view of the configuration of the lens array sheet for each step of the manufacturing method shown in FIG. 2, respectively. Here, the reference numerals of FIG. 3A-3C correspond to those of A-C in FIG. 2.

In the manufacturing method, firstly, a sheet-like lens side base material 140 is continuously supplied from a lens side base material supply section 210 to an applicator 220. The applicator 220 applies UV curable resin which has not cured to one side of the lens side base material 140. Next, the lens side base material 140 is continuously supplied to a cylindrical lens forming roll 230 having the outer surface on which the pattern of lenses 120 is formed. Rolls 232 and 233 facing the lens forming roll 230 are arranged along the direction to which the lens side base material 140 is supplied. The lens side base material 140 is sandwiched between the lens forming rolls 230 and 232, and between the lens forming rolls 230 and 233, so that the surface to which the UV curable resin is applied is pushed onto the lens forming roll 230. Thereby the pattern on the surface of the lens forming roll 230 is transferred to the UV curable resin. Next, ultraviolet rays are irradiated by a UV lamp 240 from the outside of the lens forming roll 230 to the lens side base material 140 pushed onto the lens forming roll 230, so that the UV curable resin applied to the lens side base material 140 is cured. Thereby the surface of the lens side base material 140 takes the form of lenses 120 as shown in FIG. 3a. Here, ionizing radiation such as electron beam and gamma ray may be used instead of the ultraviolet ray.

The lens side base material 140 having one side on which the lenses 120 are formed passes through a pair of laminating rolls 260 and 262 with the light shielding side base material 160 supplied from a light shielding side base material supply section 250 so that the lens side base material 140 and the light shielding side base material 160 are laminated each other. Here, in the light, shielding side base material 160 supplied from the light shielding side base material supply section 250, a light shielding layer 170 is formed on a surface opposed on the surface laminated on the lens side base material 140 as shown in FIG. 3B.

Next, the sheet as shown in FIG. 3B enters an infrared ray irradiating device 270. Here, infrared light is irradiated to the surface of the incident side on the sheet by a YAG laser, and the position around the focal point of the lenses 120 on the light shielding layer formed on the surface of the observing side on the sheet is exposed by using a focusing action of the plurality of lenses 120 formed on the surface of the incident side on the sheet. The exposed portion is stress-ruptured and flaked away, so that a light shielding pattern as shown in FIG. 3C can be formed.

According to the manufacturing method shown in FIG. 2-3C as described above, the light shielding side base material 160 is laminated on the lens side base material 140 after forming the lenses 120 on the lens side base material 140. Therefore, the shape of lenses 120 formed on one surface of the lens side base material 140 can be changed without changing the thickness of the lens side base material 140 and a setting of an apparatus for forming the lenses 120, such as a clearance for conveying the lens side base material 140 between the lens forming roll 230, and the rolls 232 and 233. Additionally, the lens pattern is arranged on the circumference surface of the lens forming roll 230 and ultraviolet rays are irradiated from the outside of the lens forming roll 230. Therefore, the lenses 120 can be easily and simply formed in comparison with the case that ultraviolet rays are irradiated from the inside of the lens forming roll 230.

In the present embodiment, a material of which refractive index is within 1.4-1.65 is used for the UV curable resin i.e. material for the lenses 120 applied to the one surface of the lens side base material, among the UV curable resin which can transmit visible light. If any material of which refractive index is less than 1.4, the lenses 120 will not have enough lens power and cannot diffuse incident light with an adequate angle. Meanwhile, if any material of which refractive index is more than 1.65 is used, light incident on the lenses 120 reflects internally, thus lowering transmission efficiency as a screen depending on a shape of the lens.

The UV curable resin includes monomer, pre-polymer, polymer, photopolymerization initiator and the like. The characteristics of the UV curable resin may be adjusted by changing the composition of the monomer, pre-polymer, polymer and photo-polymerization initiator. The monomer and prepolymer contain basically at least one or more functional group. The photo-polymerization initiator generates ions or radicals when irradiated by UV.

Here, the functional group is an atomic group or a bonding pattern that causes reaction of vinyl group, carboxyl group, hydroxyl group and the like. It is preferable to use one that has the vinyl group such as an acrylyl group having excellent curableness to UV because the resin is cured by irradiating UV in the manufacturing method of the present embodiment. Such monomer having the acrylyl group may be selected from known monomers. For example, they may be 2-ethylhexyl acrylate, 2-hydroxyethyl acrylate, 2-hydroxypropyl acrylate, dicyclopentenyl acrylate and 1,3-butanediol diacrylate. Besides them, they may be 1,4-butanediol diacrylate, 1,6-hexanediol diacrylate, diethylene glycol diacrylate, polyethylene glycol diacrylate and tripropylene glycol diacrylate. Still more, they may be ones of bifunctional group such as dimethyloltricyclodecan diacrylate and ones of trifunctional group or more such as trimethylolpropane triacrylate, pentaerythritol triacrylate and dipentaerythritol hexaacrylate. Among the monomers described above, ones in the trifunctional group or less are preferably used from the aspects that they excel in the flexibility because their film hardness after curing becomes HB or less, that their cross-linking density is small and their volumetric shrinkage rate is low and that they have excellent curl resistance.

It is preferable to use prepolymer together with the monomers described above in the present embodiment. The prepolymer used in the present embodiment may be polyester acrylate, epoxy acrylate and urethane acrylate. It is preferable to use ones of trifunctional groups or less, or more preferably to use ones of bifunctional group or of trifunctional group, from the aspect of low volumetric shrinkage and flexibility.

The photo-polymerization initiator may be acetophenone series, benzophenone series, Michler's ketone series, benzyl series, benzoin system, benzoinether series and benjildimetylketal series. Besides them, it may be carbonyl compounds such as benzoinbenzoate series and .alpha.-acyloxymester series, sulfur compounds such as tetramethylthiram monosulfide and thioxanethone group, and phosphide such as 2, 4, 6-trimethyl benzoyl diphenyl phosphine oxide. These are used singularly or by mixing two or more. A doping amount of the photo-polymerization initiator is preferable to be 0.1 to 20 parts of the monomer and/or prepolymer components(phr), or more preferably to be 0.5 to 15 phr. When the ratio of the photo-polymerization initiator is below the range described above, the curability becomes low and when it exceeds the range, the initiator bleeds out after curing. Accordingly, it is preferable to set the ratio within the range in order not to cause such problems.

Still more, various additives may be used in order to control the characteristics and properties of the resin components before, during and after curing or the characteristics and properties of the cured film in the present embodiment. Here, as the substance for controlling the characteristics and properties of the resin before curing, there are coating stabilizer (antigelling agent, anticuring agent), thickeners (for improving applicability) and others. As the substance for controlling the characteristics of the resin during curing, there are photo-polymerization accelerator, light absorbing agent (both for adjusting behavior of curing) and others. As the substance for controlling the film characteristics after curing, there are plasticizer (for improving flexibility) and UV absorbing agent (for giving light fastness).

Polymer may be added to the UV curable resin used in the present embodiment from the aspect of strength, flexibility and curling resistance. Here, the type of the polymer may be known polymer such as polyester resin, acrylic resin, urethane resin, epoxy resin and the like.

Preferably, a plastic sheet or plastic film is used for the lens side base material 140. The material of the lens side base material 140 may be acrylic resin, methacrylic resin, polystyrene, polyester, polyolefin, polyamide, polycarbonate and polyether. Or, it may be polyimide, polyetherimide, polyamide-imide, polyether sulfone, maleimide resin, polyvinyl chloride, poly(metha)-acrylic ester, melamine resin, triacetylcellulose resin and norbornene resin. Their copolymers, blends or cross-linked materials may be also used. However, a biaxial oriented polyethylene telefphthalate film is preferable among the polyester films from an aspect of balance of its optical characteristics such as transparency and mechanical strength.

It is not limited to the applicator 220 which applies UV curable resin to one side of the lens side base material 140, but it has to be capable of applying the UV curable resin in the uniform thickness. A doctor blade and a die coater are preferred, for example. It is appropriate that the thickness of applying the UV curable resin to one side of the lens side base material 140 by the applicator 220 is 0.01-0.2 mm, however it is changed dependent on a shape of the lenses 120 to be formed. Here, the thickness of application can be adjusted based on a viscosity of resin or a feed seed of the lens side base material 140.

It is preferred that the lens forming roll 230 having the surface on which the pattern reverse to that of the lenses 120 is formed by providing such as a cut metal mold and a Electroforming Mold which is obtained by a cutting work or a resin mold duplicated from the metal mold and the Electroforming Mold by a predetermined method on the surface of the roll. Additionally, the method of forming the lenses 120 is not limited to the method of the present embodiment, which uses a roll mold but a planer mold is applicable. However when the lens side base material 140 is made of a flexible plastic film, the roll mold is preferred because of being capable of continuously forming the lenses 120 over the flexible lens side base material 140. Thereby the lenses 120 can be efficiently manufactured.

In the manufacturing process of the lens array sheet 100, the light shielding side base material 160 is laminated on the lens side base material 140 after the UV curable resin is cured by irradiating ultraviolet rays from the UV lamp 240. Accordingly, the light shielding side base material 160 may contain a UV absorber. Thereby when the lens array sheet is used as such as a transmission screen, the lens side base material 140 can be prevented from being deteriorated with ultraviolet rays contained in the outside light.

In the same way, since the light shielding side base material 160 is laminated on the lens side base material 140 after the lens side base material 140 is cured, the light shielding side base material 160 may contain dye which can absorb visible light. In this case, it is preferred that the dye absorbs middle wavelength among each wavelength of image light RGB in a rear projection television. Thereby the middle wavelength among the outside light incident on the lens array sheet 100 is absorbed and does not contribute to reflect, so that the contrast between the image light and the outside light can be improved.

Still more, lens side base material and the light shielding side base material are laminated with the adhesive layer 150 to which adhesive is applied in the present embodiment, however it is not limited to that. For example, solvent may be applied to the surface of the observing side on the lens side base material 140 and then, the surface to which the solvent has been applied may be laminated on the surface of the incident side on the light shielding side base material 160. Alternatively, solvent may be applied to the surface of the incident side on the light shielding side base material 160 and then, the surface to which the solvent has been applied may be laminated on the surface of the observing side on the lens side base material 140. Here, the solvent used for the above method may be organic solvent (good solvent) having a high affinity to each base material. The organic solvent dissolves the applied surface of the base material and attaches the lens side base material 140 and the light shielding side base material 160 each other. After attaching them, the organic solvent passes through the base materials, and disperses and evaporates. According to the above-described method, the lens side base material 140 and the light shielding side base material 160 can be laminated without any refractive index difference generated by using the adhesive layer 150.

It is preferred that the light shielding layer 170 is obtained by dispersing filler components in binder resin. The filler components may be metallic particles and oxide thereof, or pigment and dye. It is preferred that the color tone of the filler components is black for visible light. Thereby the filler components absorbs the outside light causing noise. For the black pigment for visual light, carbon black, titanium black or the like is used. Still more, when dye is used, it is preferable to use black dye of which sunlight fastness is 5 or more from the aspect of light fastness and others. Further, it is most preferable to use azo black dye from the aspects of dispersibility, compatibility with the resin and general-versatility. As binder resin for dispersing or dissolving the pigment or dye described above, the known resin such as acrylic resin, urethane resin, polyester resin, novolac resin, polyimide, epoxy resin, chloroethylene-vinyl acetate copolymer, nitrocellulose and the like may be used.

The method of forming the light shielding pattern 180 may include stress-rupturing using not only infrared rays but also the other energy rays. When any energy ray different from visible light, such as infrared ray, is used, the optical path of the energy ray is displaced with the path of visible light for the case of the image light is transmitted because of the refractive index dependency of the lenses 120, the lens side base material 140 and the light shielding side base material 160. As means for correcting the displacement, infrared rays used for exposure may be diffused at a predetermined angle, or an exposure may be executed by swinging the optical axis of exposing light within ±10 degree from the optical axis of the lenses 120. Alternatively, those are executed at the same time.

Additionally, the method of forming the light shielding pattern 180 is not limited to exposing and stress-rupturing the light shielding layer 170. As another method, a transparent photosensitive adhesive layer and a black sheet may be used. In this case, firstly, a transparent photosensitive adhesive layer is applied to the surface of the observing side on the light shielding side base material 160, and the surface of the incident side on the light shielding side base material 160 and the surface of the observing side on the lens side base material 140 are laminated each other. Then, energy rays such as ultraviolet rays are irradiated from the lenses 120 side and the photosensitive adhesive layer adjacent to the focal point of the lenses 120 is exposed, so that the adhesiveness is lost. Then, a black sheet with a separate substrate is laminated on the photosensitive adhesive layer and then, the separate substrate is removed. Thereby a part of black sheet which has been exposed in the photosensitive adhesive layer is removed along with the separate substrate, and the other part of black sheet which has not exposed remains in the light shielding side base material 160, so that the light shielding pattern 180 can be formed.

It is preferred that the position of the light shielding layer 170 with respect to the optical axial direction of the lenses 120 is adjacent to the focal point of the lenses 120. Thereby when the light shielding pattern 180 is formed, the contrast of the energy rays at exposing can be improved. According to the present embodiment, the position of the light shielding layer 170 with respect to the optical axial direction of the lenses 120 can be changed only by changing the thickness of the light shielding side base material 160. Therefore, in the method for manufacturing the lens array sheet 100 shown in FIG. 2, plural kinds of lens array sheets 100 having lenses 120 with various focal distances can be easily manufactured without changing the thickness of the lens base material 140. Additionally, the thickness of the lens side base material 140 can be less than the focal distance of the lenses 120 as described above. Therefore, when the lens side base material supply section 210 draws the lens side base material 140 which is wound as a roll and supplies the same, the lens side base material 140 can be easily drawn, for example. Additionally, the lens side base material 140 can be easily wound around the lens forming roll 230, and the roll 232 and 233. Thus, the lens array sheet 100 can be more efficiently manufactured.

As described above, in the lens array sheet 100 according to the present embodiment, the thickness of the lens array sheet 100 can be a thickness allows the position of the light shielding pattern 180 to become the position of the focal distance of the plurality of lenses 120 in the lens array sheet 100 without changing the thickness of the lens side base material 140. Therefore, the lens array sheet 100 in which the ratio of the light shielding pattern 180 to the surface of the observing side on the light shielding side base material 160 is increased, that is, the contrast of the image light is improved can be manufactured without changing the thickness of the lens base material 140.

Additionally, in the lens array sheet 100 shown in FIG. 1-3(C), spherical lenses 120 are arranged in a matrix in a plane, however, the shape and the arrangement of the lenses 120 are not limited to that. For another example, curved lenticular lenses may be arranged such that each bus-bar thereof is parallel.

Still more, the lens array sheet 100 shown in FIG. 1-3(C) has two base materials such as the lens side base material 140 and the light shielding side base material 160, however, further base material can be used, so that the lens array sheet 100 may have more than three layers.

While the present invention has been described with the embodiment, the technical scope of the invention not limited to the above described embodiment. It is apparent to persons skilled in the art that various alternations and improvements can be added to the above-described embodiment.

What is claimed is:

1. A lens array sheet comprising:
a transparent sheet-like lens side base material;
a plurality of lenses formed on a one surface of the lens side base material;
a transparent sheet-like light shielding base material laminated on the rear surface of the surface laminated on the lens side base material; and
a light shielding pattern formed on the rear surface of the surface laminated on the lens side base material in the light shielding side base material that transmits visible light at a part corresponding to the focal point of the plurality of lenses and shields the visible light at the other part.

2. The lens array sheet as set forth in claim 1, wherein the light shielding side base material contains an ultraviolet absorber.

3. The lens array sheet as set forth in claim 1, wherein the lens side base material and the light shielding side base material are laminated each other with adhesive or binder.

4. The lens array sheet as set forth in claim 1, wherein the thickness of the lens side base material is less than the focal distance of the plurality of lenses.

5. The lens array sheet as set forth in claim 4, wherein the thickness of the light shielding side base material allows the position of the light shielding pattern to become the position of the focal point of the plurality of lenses.

6. A method for manufacturing a lens array sheet, comprising:
providing a sheet-like lens side base material which is made of a transparent UV curable resin;
forming a plurality of lenses on one surface of the lens side base material by pushing the UV curable resin onto a lens pattern and irradiating the same with ultraviolet rays;
providing a light shielding side based material with a photosensitive material layer on one surface of a transparent sheet;
laminating the rear surface of the one surface of the lens side base material and the rear surface of the one surface of the light shielding side base material each other; and
curing the photosensitive material layer at the part corresponding to the focal point of the plurality of lenses in the light shielding side base material by irradiating light from the one surface of the lens side base material to form a light shielding pattern.

7. A method of manufacturing a lens array sheet, comprising:
providing a transparent lens side base material made of UV curable resin;
forming a plurality of lenses on a first surface of the lens side base material by pushing the UV curable resin onto a lens pattern and irradiating the same with ultraviolet rays;
providing a light shielding side based material with a light shielding layer on one surface of a transparent sheet;
laminating the rear surface of the one surface of the lens side base material and the rear surface of the one surface of the light shielding side base material each other; and
stress-rupturing the light shielding layer at the part corresponding to the focal point of the plurality of lenses in the light shielding side base material by irradiating light from the one surface of the lens side base material to form a light shielding pattern.

8. The method of manufacturing the lens array sheet as set forth in claim 6, wherein the lens pattern is provided on the side surface of a cylindrical shape rotating around an axis, and ultraviolet rays are irradiated from the outside of the cylindrical shape.

9. The method of manufacturing the lens array sheet as set forth in claim 7, wherein the lens pattern is provided on the side surface of a cylindrical shape rotating around an axis, and ultraviolet rays are irradiated from the outside of the cylindrical shape.
